(19) United States
(12) Patent Application Publication
(10) Pub. No.: US 2026/0127709 A1
(43) Pub. Date: May 7, 2026

(54) FEED-FORWARD GAUSSIAN SPLATTING

(71) Applicant: QUALCOMM Incorporated, San Diego, CA (US)

(72) Inventors: Junmin WU, San Diego, CA (US); Khalid TAHBOUB, San Diego, CA (US); Jamie Menjay LIN, San Diego, CA (US); Scott Benjamin LEASK, Philadelphia, PA (US); Qiqi HOU, San Diego, CA (US); Chen FENG, Richmond Hill (CA); Kai WANG, San Diego, CA (US)

(21) Appl. No.: 19/273,963

(22) Filed: Jul. 18, 2025

Related U.S. Application Data
(60) Provisional application No. 63/717,228, filed on Nov. 6, 2024.

(51) Int. Cl. G06T 5/20; G06T 5/70

(52) U.S. Cl. CPC G06T 5/20; G06T 5/70

(57) ABSTRACT

Certain aspects of the present disclosure provide techniques and apparatus for machine learning. In an example method, Gaussian kernels parameterized by a plurality of parameters corresponding to a set of attributes is accessed. A set of norm values for the set of attributes is determined based on the set of parameters, and a noise measure is generated based on the set of norm values. A set of rendered images is generated based on the Gaussian kernels and the first noise measure. A set of losses is generated based on the set of rendered images, and the plurality of parameters is updated based on the set of losses. An output rendered image is generated based on the updated plurality of parameters for the Gaussian kernels.

### CROSS-REFERENCE TO RELATED APPLICATION(S)

The present application for patent claims the benefit of and priority to U.S. Provisional Patent Application No. 63/717,228, filed Nov. 6, 2024, which is hereby incorporated by reference herein in its entirety for all applicable purposes.

### INTRODUCTION

Aspects of the present disclosure relate to machine learning.

A wide variety of machine learning model architectures have been trained to perform an assortment of diverse tasks, including computer vision tasks, language tasks, classification and regression tasks, generative tasks, and the like. Recently, Gaussian splatting has been used for view synthesis, which involves learning to generate imagery of a subject or scene from one or more points of view based on images captured from different points of view. For example, given a set of images depicting a scene, Gaussian splatting may be used to generate images depicting the scene from other points of view not reflected in the training set of images (e.g., to generate a video that would be captured by a camera moving around the space, such as between two of the training images).

### BRIEF SUMMARY

Certain aspects of the present disclosure provide a processor-implemented method, comprising: accessing a plurality of Gaussian kernels parameterized by a plurality of parameters, wherein the plurality of parameters comprises, for each respective Gaussian kernel of the plurality of Gaussian kernels, a respective set of parameters for a set of attributes; determining a first set of norm values for the set of attributes based on the set of parameters; generating a first noise measure based at least in part on the first set of norm values; generating a first set of rendered images based on the plurality of Gaussian kernels and the first noise measure; generating a first set of losses based at least in part on the first set of rendered images; updating the plurality of parameters based on the first set of losses; and generating an output rendered image based on the updated plurality of parameters for the plurality of Gaussian kernels.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for feed-forward Gaussian splatting, according to some aspects of the present disclosure.

FIG. 2 depicts an example workflow for Gaussian perturbation scaling for feed-forward Gaussian splatting, according to some aspects of the present disclosure.

FIG. 3 is a flow diagram depicting an example method for feed-forward Gaussian splatting with Gaussian perturbation scaling, according to some aspects of the present disclosure.

FIG. 4 is a flow diagram depicting an example method for feed-forward Gaussian splatting via norm buffering, according to some aspects of the present disclosure.

FIG. 5 is a flow diagram depicting an example method for feed-forward Gaussian splatting with gradient replacement, according to some aspects of the present disclosure.

FIG. 6 is a flow diagram depicting an example method for feed-forward Gaussian splatting, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for efficient feed-forward Gaussian splatting are provided.

Gaussian splatting involves techniques for view synthesis that can learn, from a relatively small set of static images depicting a scene or object, to generate new images of the scene or object from virtually any position and orientation in three-dimensional space. Generally, Gaussian splatting involves learning values for attributes used to define a set of Gaussian kernels in three-dimensional space. For example, for each kernel, the computing system may seek to learn attributes such as the position of the kernel in three-dimensional space, the rotation or orientation of the kernel, the scale or size of the kernel, the color coefficient of the kernel, the opacity of the kernel, and the like. Splatting is then used to render high quality (e.g., photorealistic) images from new positions or orientations.

However, Gaussian splatting generally relies on backpropagation to learn the kernel parameters, but backpropagation may not be suitable for a wide variety of edge devices (e.g., devices executing with relatively limited capacity, such as due to limited hardware, limited battery power or energy, and the like). For example, backpropagation is often difficult or impossible to perform on-device (e.g., on user equipment (UE) such as smartphones and tablets) due to limited memory and compute capacity. In some cases, devices (including edge devices) can include specialized hardware chips for machine learning acceleration (e.g., neural processing units (NPUs)). However, these hardware units are typically configured to process data using the model in a forward pass (e.g., generating model output during runtime) and are not capable of performing training (e.g., maintaining gradients for backpropagation). Further, other hardware units such as the central processing unit (CPU) and graphics processing unit (GPU) are generally only able to conduct severely limited backward propagation operations due to limited capacity, rendering model training infeasible.

In some aspects of the present disclosure, techniques for feed-forward training of Gaussian kernels are provided. In some aspects, feed-forward training can be used to learn model parameters without a backward pass (e.g., without relying on backpropagation). However, in many feed-forward training architectures, vanishing and/or exploding gradients are common, resulting in model training divergence. Further, this non-converging behavior can become particularly problematic for feed-forward training of Gaussian splatting models. Additionally, some feed-forward training techniques rely on Gaussian noise to derive gradient signs, and therefore can be challenging to use to determine accurate magnitudes for the gradients. However, effective training of Gaussian splatting models often relies on such gradient magnitude information. As some conventional techniques cannot provide accurate gradient magnitudes, training divergence is a common concern.

In some aspects of the present disclosure, therefore, techniques including Gaussian perturbation scaling and/or gradient replacement are provided to enable effective and efficient feed-forward training of Gaussian splatting models. In some aspects, the techniques described in more detail below enable such Gaussian splatting models to be trained using fewer computational resources (e.g., reduced memory, reduced processor usage, and the like), allowing training to be performed on relatively constrained devices (e.g., edge devices, UE, and the like). For example, in some aspects, Gaussian perturbation scaling can be used to eliminate the backward components of training the Gaussian kernels, allowing for edge devices to perform feed-forward training. For example, accelerator hardware such as NPUs, which can efficiently perform the forward pass, can be used train the model without relying on any backward pass. Further, in some aspects, gradient replacement can be used to enable adaptive density control of the kernels, thereby eliminating reliance on backpropagation to train the Gaussian splatting model.

### Example Workflow for Feed-Forward Gaussian Splatting

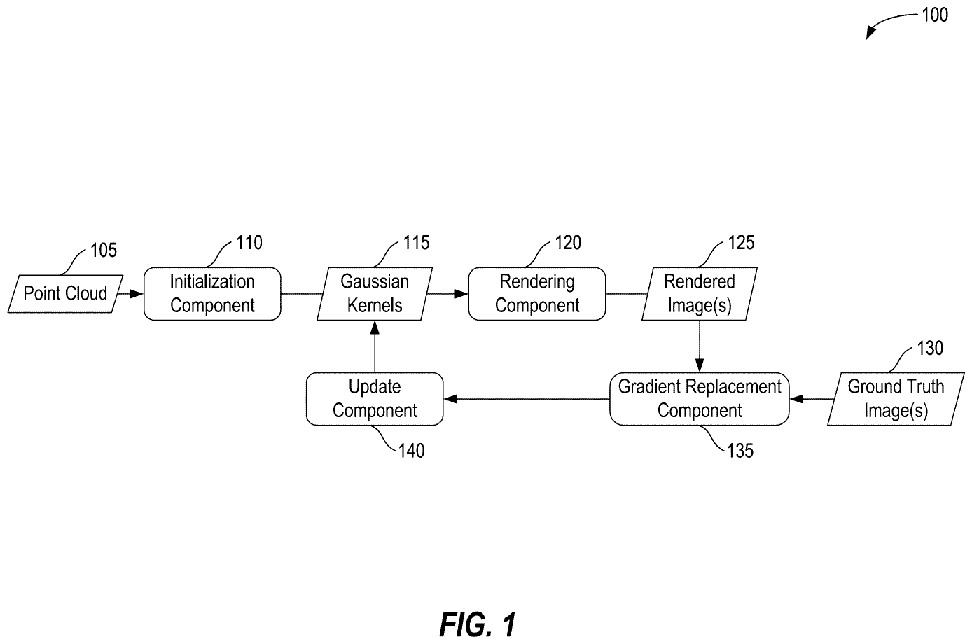

FIG. 1 depicts an example workflow 100 for feed-forward Gaussian splatting, according to some aspects of the present disclosure. In some aspects, the workflow 100 is performed by a machine learning system (e.g., a computing system capable of performing the depicted workflow 100). In some aspects, the workflow 100 is performed by an edge device (e.g., a UE).

In the illustrated example, a point cloud 105 may be accessed by an initialization component 110 to generate an initial set of Gaussian kernels 115. As used herein, “accessing” data may generally include receiving, requesting, retrieving, generating, collecting, obtaining, or otherwise gaining access to the data. For example, the initialization component 110 may generate the point cloud 105, or may receive the point cloud 105 from another source. In some aspects, the point cloud 105 may be randomly initiated (e.g., randomly placing points in a three-dimensional (3D) virtual scene). In some aspects, the point cloud 105 may be initialized in other ways (e.g., clustered near the center of the scene, initialized based on ground truth images of the scene, and the like). In some embodiments, rather than a point cloud 105, the initialization component 110 may generally use any representation of one or more locations in a virtual three-dimensional space to initialize the kernels.

Generally, the set of Gaussian kernels 115 corresponds to a set of three-dimensional (3D) kernels in a virtual 3D space, where each kernel is defined by a set of one or more attributes. For example, in some aspects, each kernel of the set of Gaussian kernels 115 is a 3D ellipsoid with parameters such as a position in 3D space (e.g., a three-tuple or a tensor or vector having three elements, such as positions according to a coordinate system defined by three axes), an orientation or rotation in 3D space (e.g., defined as a quaternion with four elements), a scale or size (e.g., in three dimensions, defined by three corresponding elements), a color value, an opacity value (e.g., a value between zero and one), and the like.

Generally, there may be any number of kernels in the set of Gaussian kernels 115. In some aspects, to generate the Gaussian kernels 115, the initialization component 110 can initialize values for each parameter of each kernel (e.g., using the 3D location of each point in the point cloud 105 as the center position of a corresponding Gaussian kernel 115, and randomly initializing values for each other attribute of each kernel).

As illustrated, the set of Gaussians kernels 115 is accessed by a rendering component 120, which generates one or more rendered images 125 depicting the Gaussian kernels 115 (e.g., depicting projections of the kernels). Generally, each rendered image 125 is a two-dimensional (2D) image corresponding to the Gaussian kernels 115. For example, in some aspects, the Gaussian kernels 115 can be projected to 2D, and blending can be used to determine the color value of each pixel in each rendered image 125 (e.g., where the color of a given pixel is determined based on the opacity and color of each Gaussian kernel 115 that is intersected by a ray, from a virtual camera, corresponding to the pixel. For example, for each pixel, the rendering component 120 may, for each kernel covered by or corresponding to the pixel, multiply the kernel's opacity by the kernel's color. By summing these (multiplied) values for all kernels corresponding to the pixel, the rendering component 120 can determine the color of the pixel.

In the illustrated example, the rendered images 125 are accessed by a gradient replacement component 135. In some conventional architectures, the rendered images 125 may be evaluated to generate one or more loss values which may then be used to refine the kernel parameters via backpropagation. However, as discussed above, this backpropagation relies on substantial computational resources that are not often available in many systems.

In the illustrated example, the gradient replacement component 135 can instead evaluate the rendered images 125 and a set of ground truth images 130 to facilitate feed-forward training. The ground truth image(s) 130 generally correspond to 2D images depicting the scene(s) and/or object(s) that the machine learning system is seeking to recreate. In some aspects, the gradient replacement component 135 can use Gaussian perturbation scaling to enable feed-forward training, as discussed in more detail below. For example, in some aspects, the gradient replacement component 135 can generate a noise measure based on the values of each kernel attribute for the set of Gaussian kernels 115 (e.g., generating noise for each attribute based on the norm of the values for the attribute), and use this scaled noise to perturb the Gaussian kernels 115 prior to generating the rendered image(s) 125. In some aspects, the machine learning system may perturb the kernels by adding the noise measure to each (and generating a corresponding rendered image 125), and/or may perturb the kernels by subtracting the noise measure from each (and then generating a rendered image 125 of the perturbed kernels). The gradient replacement component 135 may then generate a gradient replacement based on these images.

As illustrated, the update component 140 then uses the generated gradient to update the parameter(s) of the Gaussian kernels 115. This process can be repeated iteratively until one or more termination criteria are met, such as model convergence (e.g., when the gradients are sufficiently small).

For example, for each iteration t∈[0, . . . . T], the gradient replacement component 135 may determine the average norm (e.g., the L2 norm) for each attribute used to define the Gaussian kernels 115, as discussed in more detail below (e.g., the norm of the scales of each kernel, the norm of the orientations, and the like). This may be referred to as normₜ in some aspects. The gradient replacement component 135 may then generate a noise measure vₜ˜ [symbol] (0,1)*λ*normₜ, where [symbol] (0,1) is a normal distribution having a mean of zero and a standard deviation of one, and λ is a hyperparameter. In some aspects, the noise measure comprises a noise for each attribute used to define the Gaussian kernels 115. For example, for the position attribute (which may be defined as a 3-tuple for each kernel), the gradient replacement component 135 may generate a 3-tuple noise measure (e.g., where the noise value for each dimension in the position attribute is defined based on the norm of that dimension across all of the kernels).

In some aspects, the gradient replacement component 135 (or another component) may perturb the Gaussian kernels 115 by adding the noise measure to each kernel, generate a rendered image 125 of these perturbed kernels (or projections thereof), and compare this rendered image 125 with a corresponding ground truth image 130 to generate a loss. This loss may generally be formulated using a variety of formulations, such as mean-squared error (MSE), learned perceptual image patch similarity (LPIPS), structural similarity index measure (SSIM), and the like. More specifically, the gradient replacement component 135 may, based on a rendered image f(θₜ+vₜ) (where f( ) represents rendering an image of the projection of a set of Gaussian kernels θₜ at iteration t), generate a first loss l₊. Similarly, the kernels may be perturbed by subtracting the noise (e.g., to generate a rendered image f(θₜ−vₜ)) and compare this image with the ground truth to generate a second loss l₋.

In some aspects, the gradient replacement component 135 may then generate a gradient

$${g}_{t} = \vert {v}_{t} \vert sign ( \frac{{l}_{+} - {l}_{-}}{{v}_{t}} )$$

for the t-th iteration. This gradient may then be used by the update component 140 to update the parameters of the kernels, such as using θₜ₊₁←θₜ−ηgₜ, where η is a hyperparameter (e.g., the learning rate).

In this way, the machine learning system can enable feed-forward training of the Gaussian kernels 115 without relying on backpropagation, substantially reducing the computational expense of the process. Further, by using Gaussian perturbation scaling to perturb the kernels prior to generating the loss terms, the machine learning system can improve convergence of the model (e.g., reducing the number of iterations performed prior to convergence). As discussed in more detail below, in some aspects, rather than determining the parameter norms at each iteration, the machine learning system may determine these norms during a subset of iterations (e.g., during “norm update iterations”). The determined norms can then be re-used for multiple iterations (e.g., until the next norm update iteration). Further, as discussed in more detail below, in some aspects, the machine learning system may use a gradient replacement approach to enable adaptive density control of the Gaussian kernels 115 during some iterations, which can substantially improve the training process (e.g., improving the resulting rendered images and relying on fewer update iterations to converge).

### Example Workflow for Gaussian Perturbation Scaling for Feed-Forward Gaussian Splatting

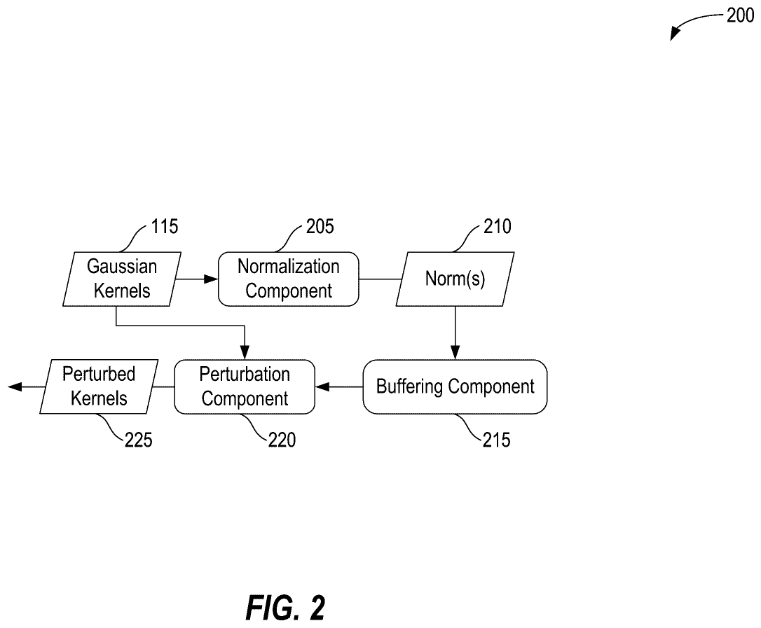

FIG. 2 depicts an example workflow 200 for Gaussian perturbation scaling for feed-forward Gaussian splatting, according to some aspects of the present disclosure. In some aspects, the workflow 200 is performed by an edge device (e.g., a UE). In some aspects, the workflow 200 may generally be performed by any computing system (e.g., the machine learning system discussed above with reference to FIG. 1). In some aspects, the workflow 200 is performed by the gradient replacement component 135 of FIG. 1. That is, rather than receiving rendered images immediately, the gradient replacement component may receive Gaussian kernels 115 to generate a set of perturbed kernels 225, and these perturbed kernels may be processed by the rendering component to generate rendered images that can then be used (e.g., by the gradient replacement component) to generate loss(es) for the kernels.

In some aspects, the workflow 200 is used to perform training of the Gaussian kernels (e.g., each iteration), as discussed above. In the illustrated example, the set of Gaussian kernels 115 is accessed by a normalization component 205, which generates a set of norms 210. In some aspects, the normalization component 205 generates one or more norms 210 for the attributes used to define the Gaussian kernels 115. For example, as discussed above, suppose the Gaussian kernels 115 include M kernels. In some aspects, if the “opacity” attribute is defined as a single scalar value, the normalization component 205 may treat the opacity attributes of the entire set of Gaussian kernels 115 as an M×1 vector. Similarly, if the position and scale attributes each correspond to three values (e.g., one for each of three dimensions), the normalization component 205 may treat the collective positions and scales each as respective M×3 matrices. As additional examples, the rotation attribute (which may be defined using four parameters for each kernel) may be defined as an M×4 matrix, and the color coefficient attribute (which may be represented using, for example, forty-nine parameter values) may be defined as an M×49 matrix.

In some aspects, the normalization component 205 generates the norms 210 (referred to as “norm values” in some aspects) as the average value or norm for each of these attributes. For example, the norms 210 may include the average position of the set of kernels (e.g., a 1×3 vector generated by averaging the positon values along each dimension across all kernels), the average rotation (e.g., a 1×4 vector), the average scale (e.g., a 1×3 vector), the average color coefficient (e.g., a 1×49 vector), and/or the average opacity (e.g., a scalar value). Generally, the normalization component 205 may use a variety of norm values, including the L1 norm, the L2 norm, the Lp norm, the L-infinity norm, and the like.

In some aspects, the normalization component 205 may periodically determine or generate the norms 210 based on the updated Gaussian kernels 115. That is, rather than determining updated norms 210 for each iteration (based on the new set of Gaussian kernels 115 for each iteration), the normalization component 205 may update the norms 210 periodically (e.g., every N iterations). In some aspects, the iterations where the normalization component 205 generates updated norms 210 may be referred to as “norm update iterations.” In some aspects, rather than using a fixed period (e.g., every N iterations), the normalization component 205 may define N as a function of training steps or iterations. For example, the normalization component 205 may define N=e^{k*step}, where k is a hyperparameter and step indicates the current iteration number (e.g., beginning with zero and incrementing for each iteration of updating the kernels). In this way, N may be relatively small during early training stages (e.g., causing the norms 210 to be updated more frequently) and relatively larger during subsequent parameter update iterations (causing the norms 210 to be updated less frequently during these later iterations).

In the illustrated example, for each norm update iteration, the norms 210 may be buffered (e.g., stored) by a buffering component 215 (e.g., in a memory buffer). This can allow the norms 210 to be reused across multiple parameter update iterations (e.g., if the norms are only updated periodically). In addition to reduced computational expense, this periodic norm updating may improve training stability and convergence (e.g., allowing the machine learning system to generate high accuracy output using fewer training iterations).

As illustrated, during every parameter iteration (e.g., each training step of updating the Gaussian kernels 115), a perturbation component 220 can access the most up-to-date set of norms 210 from the buffering component 215. In the workflow 200, the perturbation component 220 also accesses the current set of Gaussian kernels 115 for evaluation. In some aspects, as discussed above, the perturbation component 220 may generate a noise measure based at least in part on the norms 210. For example, in some aspects, the perturbation component 220 may generate the noise measure vₜ for the t-th iteration as vₜ˜ [symbol] (0,1)*λ*normₜ, as discussed above. In some aspects, the perturbation component 220 generates a respective noise measure for each respective attribute (based on the corresponding attribute norm). For example, the position attribute (which may comprise three parameters) may have three corresponding noise values from the noise measure.

In the workflow 200, the perturbation component 220 can then generate a set of perturbed kernels 225, as discussed above. For example, the perturbation component 220 may generate a first set of perturbed kernels 225 by adding the noise measure to the Gaussian kernels 115 (e.g., for each attribute of each kernel, summing the parameter value(s) with the corresponding noise measure for the attribute). In some aspects, the perturbation component 220 may similarly generate a second set of perturbed kernels 225 by subtracting the noise measure from the Gaussian kernels 115 (e.g., for each attribute of each kernel, subtracting the parameter value(s) by the corresponding noise measure for the attribute).

As discussed above, these perturbed kernels 225 can then be used to generate two (or more) losses, which may be used to refine the parameters of the Gaussian kernels 115 without relying on backpropagation.

Example Method for Feed-Forward Gaussian Splatting with Gaussian Perturbation Scaling

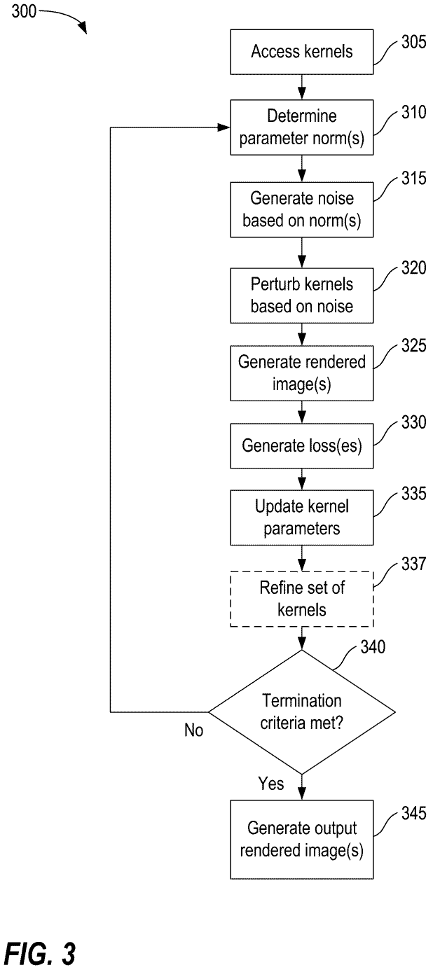

FIG. 3 is a flow diagram depicting an example method 300 for feed-forward Gaussian splatting with Gaussian perturbation scaling, according to some aspects of the present disclosure. In some aspects, the method 300 is performed by an edge device (e.g., a UE). In some aspects, the method 300 may generally be performed by any computing system (e.g., the machine learning system discussed above with reference to FIGS. 1-2).

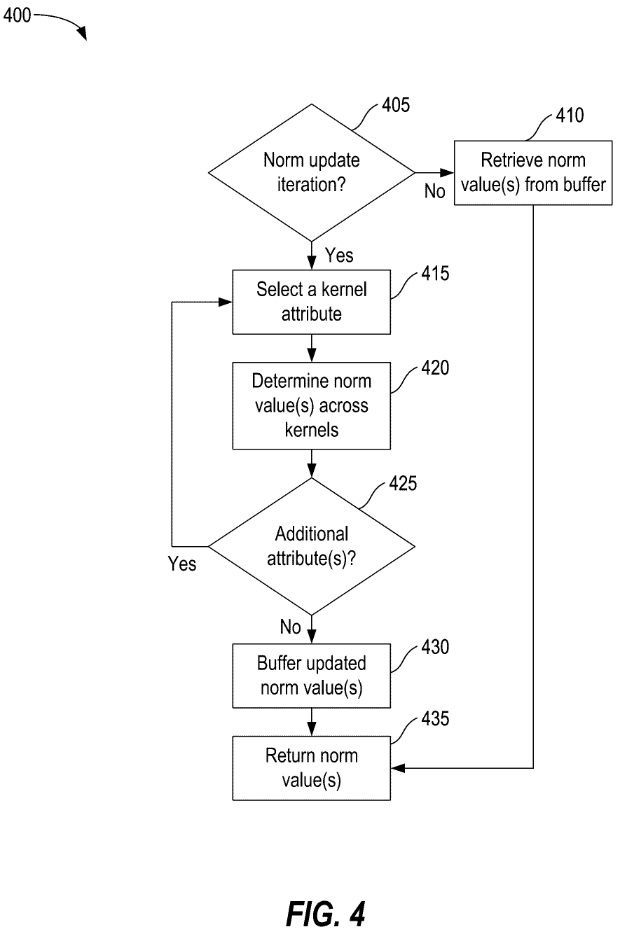

At block 305, the machine learning system accesses a current set of kernels (e.g., the Gaussian kernels 115 of FIGS. 1-2). At block 310, the machine learning system determines a set of parameter norms (e.g., the norms 210 of FIG. 2) for the kernels. For example, as discussed above, the machine learning system may generate a set of norms (e.g., if the current parameter update iteration is also a norm update iteration) or may access previously generated norms (e.g., from a prior iteration). One example method for determining the parameter norms is discussed below in more detail with reference to the method 400 of FIG. 4.

At block 315, the machine learning system generates one or more noise measures based on the determined norm(s). For example, as discussed above, the machine learning system may generate the noise as a function of the norms and a hyperparameter. In some aspects, as discussed above, the noise measure includes one or more noise values for each attribute of the kernels. For example, the noise measure may include a noise value for each parameter (e.g., for each value used to define each attribute).

At block 320, the machine learning system perturbs the accessed kernels based on the generated noise. For example, as discussed above, the machine learning system may generate a first set of perturbed kernels by adding the noise to the parameters accessed at block 305 (for each kernel), and may generate a second set of perturbed kernels by subtracting the noise from the parameters accessed at block 305 (for each kernel).

At block 330, the machine learning system generates one or more losses based on the perturbed kernels. In some aspects, the machine learning system generates a respective loss for each respective set of perturbed kernels (e.g., one for the kernels with added noise, and one for the kernels with subtracted noise). For example, as discussed above, the machine learning system may project a perturbed set of kernels to two dimensions (e.g., based on the location of a virtual camera in the three-dimensional space), and then render an image of the projected kernels. This image may then be used to compute a loss, such as by comparing the generated image and a ground truth image (e.g., using MSE or another loss formulation). In some aspects, the machine learning system may generate a set of loss(es) for each ground truth image (e.g., based on rendering an image from the corresponding camera location in the three-dimensional space).

At block 335, the machine learning system updates the parameters of the kernels (accessed at block 305) based on the generated loss(es). For example, as discussed above, for the t-th update iteration, the machine learning system may compute gradients as

$${g}_{t} = \vert {v}_{t} \vert sign ( \frac{{l}_{+} - {l}_{-}}{{v}_{t}} )$$

(where l₊ and l₋ are the losses generated at block 330 based on perturbed kernels). The machine learning system may then use these gradients to update the parameters of the kernels using gradient descent, as discussed above. In this way, the machine learning system can generate gradients and update the kernel parameters without relying on backpropagation, which substantially reduces the computational complexity and expense of the training process and may enable the process to be performed on constrained devices that could not otherwise use Gaussian splatting (e.g., edge devices or UE).

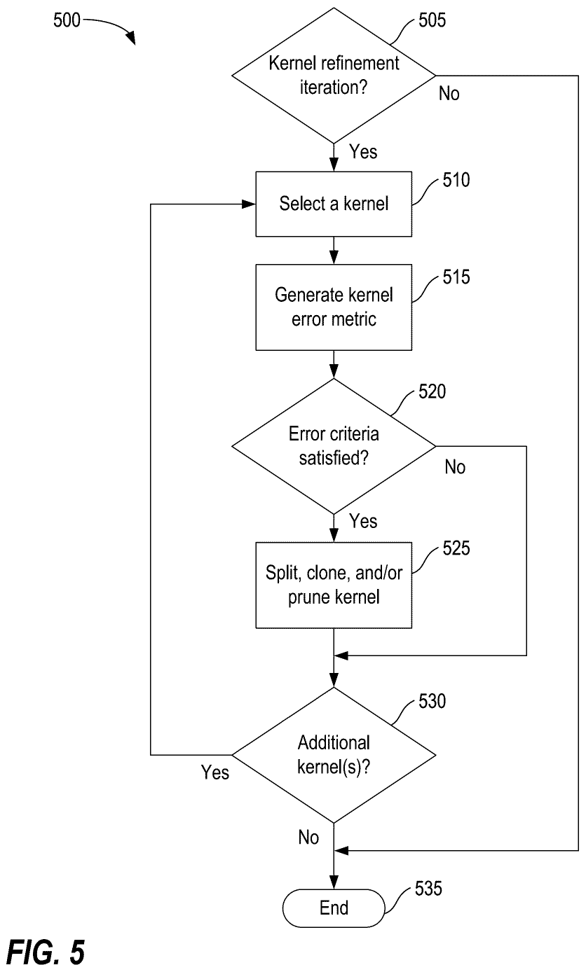

At block 337, the machine learning system can optionally refine the set of kernels using one or more adaptive density operations. In some aspects, the block 337 is optional as the machine learning system may perform the adaptive density control during only a subset of the training iterations (e.g., every M iterations). The particular operations used during the kernel refinement may vary depending on the particular implementation, and may include operations such as pruning one or more kernels (e.g., removing particular kernels from the set of kernels), cloning one or more kernels to generate two identical kernels (and, in some aspects, moving one of the cloned kernels by the direction and magnitude of the position gradient to allow the kernels to diverge during subsequent iterations), splitting one or more kernels to generate two or more smaller kernels (e.g., dividing the scale of the split kernel by a hyperparameter to generate the new scale of the two new kernels), and the like. One example method for refining the set of kernels is discussed in more detail below with reference to the method 500 of FIG. 5.

At block 340, the machine learning system determines whether one or more training termination criteria are met. The particular termination criteria may vary depending on the particular implementation, and may include considerations such as whether a defined number of iterations have been performed, whether the kernels have reached convergence (e.g., determined based on whether the magnitude of the gradients and/or losses for the most recent iteration are below a threshold), and the like.

If, at block 340, the machine learning system determines that the termination criteria are not met, the method 300 returns to block 310 to perform another training iteration. If the termination criteria are met, the method 300 continues to block 345. At block 345, the machine learning system generates one or more output rendered images based on the final set of updated Gaussian kernels (generated at block 335). For example, as discussed above, the machine learning system may project the kernels to two dimensions based on a virtual camera location, and then render an image of the (projected) kernels. The machine learning system may generally generate any number of output images from any number of camera locations (including novel locations not present in the training dataset, as discussed above).

### Example Method for Feed-Forward Gaussian Splatting Via Norm Buffering

FIG. 4 is a flow diagram depicting an example method 400 for feed-forward Gaussian splatting via norm buffering, according to some aspects of the present disclosure. In some aspects, the method 400 is performed by an edge device (e.g., a UE). In some aspects, the method 400 may generally be performed by any computing system (e.g., the machine learning system discussed above with reference to FIGS. 1-3). In some aspects, the method 400 provides additional detail for block 310 of FIG. 3.

At block 405, the machine learning system determines whether the current iteration is a norm update iteration. For example, as discussed above, every N iterations may be defined as norm update iterations, where N may be a fixed value or a dynamic value (e.g., generated based at least in part on the current training iteration). If the current iteration is not a norm update iteration, the method 400 continues to block 410, and the machine learning system retrieves the norm values (e.g., the norms 210) that were generated during a previous iteration from a buffer (e.g., the buffering component 215 of FIG. 2). The method 400 then continues to block 435, discussed in more detail below.

Returning to block 405, if the machine learning system determines that the current iteration is a norm update iteration, the method 400 proceeds to block 415, where the machine learning system selects a kernel attribute that is used to define each of the kernels (e.g., position, scale, orientation or rotation, color, opacity, and the like). Generally, the machine learning system may select the attribute using any suitable technique (including randomly or pseudo-randomly), as all kernel attributes will be processed during the method 400.

At block 420, the machine learning system determines one or more norm values for the selected attribute across the set of kernels. For example, as discussed above, the machine learning system may determine the L2 norm (or any other suitable norm) for each value of each parameter used to define the attribute. As one example, for the position attribute, the machine learning system may generate three norm values (one for each dimension) based on the position parameters of each kernel in the set.

At block 425, the machine learning system determines whether there is at least one additional attribute that has not-yet been evaluated using the method 400. If so, the method 400 returns to block 415. If not, the method 400 continues to block 430. Although the illustrated example depicts a sequential process (e.g., selecting and evaluating each attribute in sequence) for conceptual clarity, in some aspects, some or all of the attributes may be processed entirely or partially in parallel.

At block 430, the machine learning system buffers the updated norm values (generated at block 420). For example, as discussed above, the machine learning system may store the updated norms in a buffer (e.g., the buffering component 215) or other memory store, allowing the norms to be re-used during subsequent iterations.

At block 435, the machine learning system returns the norm values (e.g., the newly generated norms if the current iteration is a norm update iteration, or the retrieved or buffered norms if the current iteration is not a norm update iteration). As discussed above, the machine learning system can then use these determined norms to update the Gaussian kernels.

### Example Method for Feed-Forward Gaussian Splatting Via Gradient Replacement

FIG. 5 is a flow diagram depicting an example method 500 for feed-forward Gaussian splatting via gradient replacement, according to some aspects of the present disclosure. In some aspects, the method 500 is performed by an edge device (e.g., a UE). In some aspects, the method 500 may generally be performed by any computing system (e.g., the machine learning system discussed above with reference to FIGS. 1-4). In some aspects, the method 500 provides additional detail for block 337 of FIG. 3.

At block 505, the machine learning system determines whether the current iteration is a kernel refinement iteration (e.g., an iteration when adaptive density control is applied). For example, as discussed above, every M iterations may be defined as refinement iterations, where M may be a fixed value or a dynamic value. If the current iteration is not a refinement iteration, the method 500 terminates at block 535.

If the machine learning system determines that the current iteration is a kernel refinement iteration, the method 500 proceeds to block 510, where the machine learning system selects a kernel from the current (e.g., updated) set of Gaussian kernels. Generally, the machine learning system may select the kernel using any suitable technique (including randomly or pseudo-randomly), as each kernel will be processed during the method 500.

At block 515, the machine learning system generates a kernel error metric for the selected kernel. In some conventional systems, the kernel error used for adaptive density control is generated during the backpropagation portion of training the parameters. However, as the machine learning system may not use backpropagation (and may not even be capable of backpropagation), this conventional metric cannot be used during the method 500. In some aspects, the machine learning system may generate the kernel error metric based on pixel error, based on kernel position, and the like. Generally, the machine learning system may use a wide variety of error metrics.

For example, in some aspects, the machine learning system may, for each rendered pixel (e.g., each pixel in at least one of the rendered images generated during the training iteration), first determine the error of the pixel (referred to in some aspects as a “pixel error measure”) based on comparing the rendered image and the corresponding ground truth (e.g., using MSE, LPIPS, SSIM, and the like). The machine learning system can then determine a blending ratio of the pixel based on the subset of the Gaussian kernels that are depicted by the pixel. For example, in some aspects, the color of a given pixel may be defined based on the blending ratio(s) and color coefficients of the corresponding kernels according to

$$C = {\sum }_{i = 1}^{\vert N \vert} {T}_{i} {α}_{i} {c}_{i} ,$$

where N is the set of kernels that are depicted by the pixel (e.g., that are intersected by the ray corresponding to the pixel),

$${T}_{i} = {\prod }_{j = 1}^{i - 1} ( 1 - {α}_{i} ) , {α}_{i} = ( 1 - exp ( - {σ}_{i} {δ}_{i} ) ) ,$$

σᵢ indicates the sampling density of the ray taken with intervals δᵢ, and cᵢ is the color coefficient of the i-th kernel. In some aspects, the blending ratio of the i-th kernel may be defined as Tᵢαᵢ.

In some aspects, the machine learning system may then compute an interim error value for each pixel by multiplying the pixel error measure of the pixel with the blending ratio of the pixel. The kernel error for each Gaussian kernel may then be defined as the sum of the intermediate errors corresponding to the pixels that depict the kernel.

Although this approach is accurate, such an approach may also incur additional computational expense due to the complexity of the error metric generation process. In some aspects, other less complex methods may be used. For example, in some aspects, the machine learning system may, for each kernel, generate the error value as the difference between the current position of the kernel (or some other attribute) and the previous position (or other attribute) during the prior step. That is, the machine learning system may determine the prior position (before the current update iteration is performed) and the current position (after the update is performed), and may generate the kernel error metric based on the difference between these positions (e.g., accumulating the absolute distance between the positions).

At block 520, the machine learning system determines whether one or more error criteria are satisfied by the generated kernel error metric. For example, the machine learning system may determine whether the error metric meets or exceeds a threshold. If not, the method 500 continues to block 530, discussed below in more detail. If, at block 520, the machine learning system determines that the kernel's error metric satisfies the criteria, the method 500 continues to block 525.

At block 525, the machine learning system can split, clone, and/or prune the selected kernel. For example, in some aspects, if the scale of the selected kernel meets or exceeds a threshold, the machine learning system may determine to split the kernel into two (or more) smaller kernels. As another example, if the scale does not meet or exceed the threshold, the machine learning system may determine to clone the kernel to generate two or more kernels. In some aspects, the machine learning system may additionally or alternatively determine to prune (e.g., remove) the kernel if the kernel opacity is below a threshold, if the kernel size is above a threshold, and the like. Although not depicted in the illustrated example, in some aspects, the kernel pruning (e.g., based on opacity and/or scale) may be performed independently of the error metrics (e.g., for all kernels, regardless of whether the error criteria are satisfied).

At block 530, the machine learning system determines whether there is at least one additional kernel that has not-yet been evaluated using the method 500. If so, the method 500 returns to block 510. If not, the method 500 terminates at block 535. Although the illustrated example depicts a sequential process (e.g., selecting and evaluating each kernel in sequence) for conceptual clarity, in some aspects, some or all of the kernels may be processed entirely or partially in parallel.

As discussed above, using the method 500 to refine the set of kernels can substantially improve model convergence in some aspects.

### Example Method for Feed-Forward Gaussian Splatting

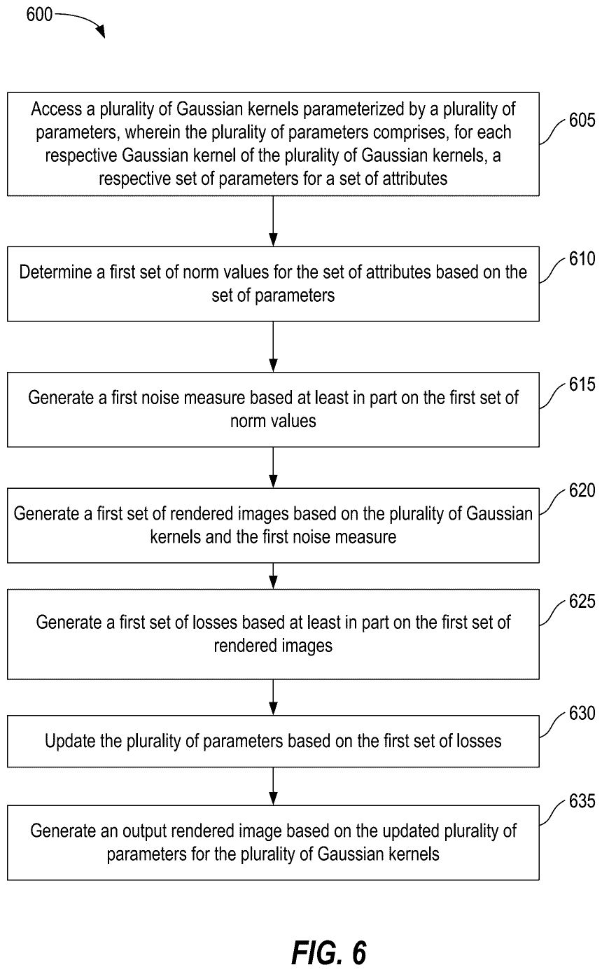

FIG. 6 is a flow diagram depicting an example method 600 for feed-forward Gaussian splatting, according to some aspects of the present disclosure. In some aspects, the method 600 is performed by an edge device (e.g., a UE). In some aspects, the method 600 may generally be performed by any computing system (e.g., the machine learning system discussed above with reference to FIGS. 1-5).

At block 605, a plurality of Gaussian kernels (e.g., the Gaussian kernels 115 of FIG. 1 and/or FIG. 2) parameterized by a plurality of parameters is accessed, wherein the plurality of parameters comprises, for each respective Gaussian kernel of the plurality of Gaussian kernels, a respective set of parameters for a set of attributes.

At block 610, a first set of norm values (e.g., the norms 210 of FIG. 2) is determined for the set of attributes based on the set of parameters.

At block 615, a first noise measure is generated based at least in part on the first set of norm values.

At block 620, a first set of rendered images (e.g., the rendered images 125 of FIG. 1) is generated based on the plurality of Gaussian kernels and the first noise measure.

At block 625, a first set of losses is generated based at least in part on the first set of rendered images.

At block 630, the plurality of parameters is updated based on the first set of losses.

At block 635, an output rendered image is generated based on the updated plurality of parameters for the plurality of Gaussian kernels.

In some aspects, the method 600 further includes determining the first set of norm values in response to determining that a current iteration of updating the plurality of parameters corresponds to a norm update iteration.

In some aspects, the method 600 furthers includes, in response to determining that a subsequent iteration of updating the plurality of parameters does not correspond to a norm update iteration, use the first set of norm values during the subsequent iteration.

In some aspects, norm update iterations are defined as a function of parameter iterations for which the plurality of parameters is updated, such that updated sets of norm values are generated more frequently during earlier parameter iterations, as compared to subsequent parameter iterations.

In some aspects, generating the first set of rendered images comprises rendering a first image subsequent to adding the first noise measure to each set of parameters of the plurality of parameters and rendering a second image subsequent to subtracting the first noise measure from each set of parameters of the plurality of parameters.

In some aspects, generating the first set of losses comprises comparing the first set of rendered images to one or more ground truth images.

In some aspects, the one or more ground truth images were captured using one or more imaging devices.

In some aspects, updating the plurality of parameters based on the first set of losses comprises computing a set of gradients based on the first set of losses and updating the plurality of parameters based on the set of gradients using gradient descent.

In some aspects, the method 600 further includes computing the set of gradients according to

$$g = \vert v \vert * sign ( \frac{{l}_{+} - {l}_{-}}{v} ) ,$$

where: g is the set of gradients, v is the first noise measure, and l₊ and l₋ are first and second losses, respectively, of the first set of losses.

In some aspects, the method 600 further includes refining the plurality of Gaussian kernels, comprising: generating a respective error value for each respective Gaussian kernel of the plurality of Gaussian kernels, and for each respective Gaussian kernel having a respective error value that satisfies one or more criteria, either: splitting the respective Gaussian kernel to form two new Gaussian kernels, or cloning the respective Gaussian kernel to form the two new Gaussian kernels.

In some aspects, generating the respective error value for each respective Gaussian kernel includes generating a respective pixel error measure for each respective pixel of a set of pixels of at least a first rendered image of the first set of rendered images based on comparing the first rendered image to a ground truth image, determining a respective blending ratio for each respective pixel of the set of pixels based on a respective subset of the plurality of Gaussian kernels that are depicted by the respective pixel, and generating the respective error value for each respective Gaussian kernel based on the pixel error measures and the blending ratios.

In some aspects, generating the respective error value for each respective Gaussian kernel includes, for each respective Gaussian kernel of the plurality of Gaussian kernels, determining a respective first position of the respective Gaussian kernel during a prior iteration of updating the plurality of parameters, determining a respective second position of the respective Gaussian kernel during a current iteration of updating the plurality of parameters, and generating the respective error value based on a difference between the respective first and second positions.

In some aspects, the method 600 is performed by a processing system corresponding to at least one of (i) an edge device or (ii) user equipment (UE).

### Example Processing System for Gaussian Splatting

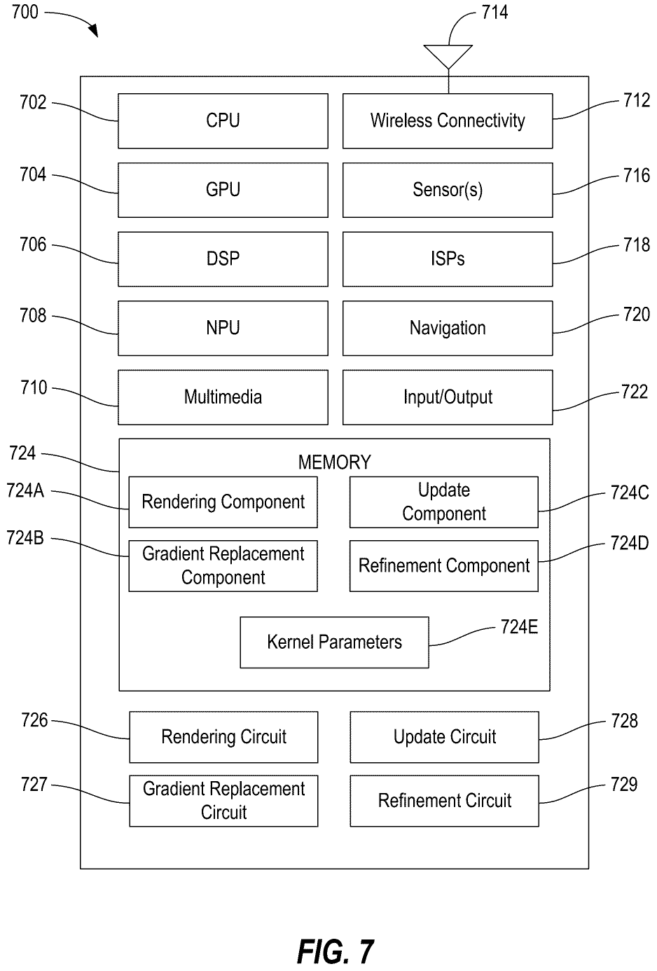

FIG. 7 depicts an example processing system 700 configured to perform various aspects of the present disclosure, including, for example, the techniques and methods described with respect to FIGS. 1-7. In some aspects, the processing system 700 may correspond to an edge device (e.g., a UE). In some aspects, the processing system 700 may generally correspond to any computing system (e.g., the machine learning system discussed above with reference to FIGS. 1-6). Although depicted as a single system for conceptual clarity, in some aspects, as discussed above, the components described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a rendering component 724A, a gradient replacement component 724B, an update component 724C, and a refinement component 724D. Although not depicted in the illustrated example, the memory 724 may also include other components. Though depicted as discrete components for conceptual clarity in FIG. 7, the illustrated components (and others not depicted) may be collectively or individually implemented in various aspects.

Further, as depicted in the illustrated example, the memory 724 may also include other data such as kernel parameters 724E (e.g., parameters for one or more attributes used to define a set of Gaussian kernels, such as positions, scales, opacities, rotations, colors, and the like.

The processing system 700 further comprises a rendering circuit 726, a gradient replacement circuit 727, an update circuit 728, and a refinement circuit 729. The depicted circuits, and others not depicted (such as an inferencing circuit), may be configured to perform various aspects of the techniques described herein.

For example, the rendering component 724A and/or the rendering circuit 726 may correspond to the rendering component 120 of FIG. 1, and may be used to generate rendered images based on the Gaussian kernels. For example, the rendering component 724A and/or the rendering circuit 726 may project the kernels to two-dimensions based on camera definitions, rendering an image of the projected kernels (e.g., during training and/or to generate the final output image(s)).

The gradient replacement component 724B and/or the gradient replacement circuit 727 may correspond to the gradient replacement component 135 of FIG. 1 and/or the normalization component 205, buffering component 215, and/or perturbation component 220, each of FIG. 2, and may be used to generate gradients for the Gaussian kernel parameters without relying on backpropagation, as discussed above.

The update component 724C and/or the update circuit 728 may correspond to the update component 140 of FIG. 1 and may be used to update the Gaussian kernel parameters using the generated gradients, as discussed above.

The refinement component 724D and/or the refinement circuit 729 may be used to perform adaptive density control (e.g., using the method 500 of FIG. 5), as discussed above. For example, the refinement circuit 729 may generate kernel error metrics and adaptively refine the set of kernels, such as by pruning, splitting, and/or cloning the kernels to improve model convergence.

Though depicted as separate components and circuits for clarity in FIG. 7, the rendering circuit 726, the gradient replacement circuit 727, the update circuit 728, and the refinement circuit 729 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 may be distributed between multiple devices.

### Example Clauses

Implementation examples are described in the following numbered clauses:

Clause 1: A method, comprising: accessing a plurality of Gaussian kernels parameterized by a plurality of parameters, wherein the plurality of parameters comprises, for each respective Gaussian kernel of the plurality of Gaussian kernels, a respective set of parameters for a set of attributes; determining a first set of norm values for the set of attributes based on the set of parameters; generating a first noise measure based at least in part on the first set of norm values; generating a first set of rendered images based on the plurality of Gaussian kernels and the first noise measure; generating a first set of losses based at least in part on the first set of rendered images; updating the plurality of parameters based on the first set of losses; and generating an output rendered image based on the updated plurality of parameters for the plurality of Gaussian kernels.

Clause 2: A method according to Clause 1, further comprising determining the first set of norm values in response to determining that a current iteration of updating the plurality of parameters corresponds to a norm update iteration.

Clause 3: A method according to Clause 2, further comprising, in response to determining that a subsequent iteration of updating the plurality of parameters does not correspond to a norm update iteration, use the first set of norm values during the subsequent iteration.

Clause 4: A method according to any of Clauses 2-3, wherein norm update iterations are defined as a function of parameter iterations for which the plurality of parameters is updated, such that updated sets of norm values are generated more frequently during earlier parameter iterations, as compared to subsequent parameter iterations.

Clause 5: A method according to any of Clauses 1-4, wherein generating the first set of rendered images comprises: rendering a first image subsequent to adding the first noise measure to each set of parameters of the plurality of parameters; and rendering a second image subsequent to subtracting the first noise measure from each set of parameters of the plurality of parameters.

Clause 6: A method according to any of Clauses 1-5, wherein generating the first set of losses comprises comparing the first set of rendered images to one or more ground truth images.

Clause 7: A method according to Clause 6, wherein the one or more ground truth images were captured using one or more imaging devices.

Clause 8: A method according to any of Clauses 1-7, wherein updating the plurality of parameters based on the first set of losses comprises: computing a set of gradients based on the first set of losses; and updating the plurality of parameters based on the set of gradients using gradient descent.

Clause 9: A method according to any of Clauses 1-8, further comprising computing the set of gradients according to

$$g = \vert v \vert * sign ( \frac{{l}_{+} - {l}_{-}}{v} ) ,$$

wherein: g is the set of gradients, v is the first noise measure, and l₊ and l₋ are first and second losses, respectively, of the first set of losses.

Clause 10: A method according to any of Clauses 1-9, further comprising refining the plurality of Gaussian kernels, comprising: generating a respective error value for each respective Gaussian kernel of the plurality of Gaussian kernels; and for each respective Gaussian kernel having a respective error value that satisfies one or more criteria, either: splitting the respective Gaussian kernel to form two new Gaussian kernels, or cloning the respective Gaussian kernel to form the two new Gaussian kernels.

Clause 11: A method according to Clause 10, wherein generating the respective error value for each respective Gaussian kernel comprises: generating a respective pixel error measure for each respective pixel of a set of pixels of at least a first rendered image of the first set of rendered images based on comparing the first rendered image to a ground truth image; determining a respective blending ratio for each respective pixel of the set of pixels based on a respective subset of the plurality of Gaussian kernels that are depicted by the respective pixel; and generating the respective error value for each respective Gaussian kernel based on the pixel error measures and the blending ratios.

Clause 12: A method according to Clause 10, wherein generating the respective error value for each respective Gaussian kernel comprises, for each respective Gaussian kernel of the plurality of Gaussian kernels: determining a respective first position of the respective Gaussian kernel during a prior iteration of updating the plurality of parameters; determining a respective second position of the respective Gaussian kernel during a current iteration of updating the plurality of parameters; and generating the respective error value based on a difference between the respective first and second positions.

Clause 13: A method according to any of Clauses 1-9, wherein the method is performed by a processing system corresponding to at least one of (i) an edge device or (ii) user equipment (UE).

Clause 14: A processing system comprising: a memory comprising processor-executable instructions; and one or more processors coupled to the one or more memories and configured to execute the processor-executable instructions and cause the processing system to perform a method in accordance with any of Clauses 1-13.

Clause 15: A processing system comprising means for performing a method in accordance with any of Clauses 1-13.

Clause 16: A non-transitory computer-readable medium comprising computer-executable instructions that, when executed by one or more processors of a processing system, cause the processing system to perform a method in accordance with any of Clauses 1-13.

Clause 17: A computer program product embodied on a computer-readable storage medium comprising code for performing a method in accordance with any of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
access a plurality of Gaussian kernels parameterized by a plurality of parameters, wherein the plurality of parameters comprises, for each respective Gaussian kernel of the plurality of Gaussian kernels, a respective set of parameters for a set of attributes;
determine a first set of norm values for the set of attributes based on the set of parameters;
generate a first noise measure based at least in part on the first set of norm values;
generate a first set of rendered images based on the plurality of Gaussian kernels and the first noise measure;
generate a first set of losses based at least in part on the first set of rendered images;
update the plurality of parameters based on the first set of losses; and
generate an output rendered image based on the updated plurality of parameters for the plurality of Gaussian kernels.

2. The processing system of claim 1, wherein the one or more processors are configured to execute the processor-executable instructions and cause the processing system to determine the first set of norm values in response to determining that a current iteration of updating the plurality of parameters corresponds to a norm update iteration.

3. The processing system of claim 2, wherein the one or more processors are configured to execute the processor-executable instructions and cause the processing system to, in response to determining that a subsequent iteration of updating the plurality of parameters does not correspond to a norm update iteration, use the first set of norm values during the subsequent iteration.

4. The processing system of claim 2, wherein norm update iterations are defined as a function of parameter iterations for which the plurality of parameters is updated, such that updated sets of norm values are generated more frequently during earlier parameter iterations, as compared to subsequent parameter iterations.

5. The processing system of claim 1, wherein, to generate the first set of rendered images, the one or more processors are configured to execute the processor-executable instructions and cause the processing system to:
render a first image subsequent to adding the first noise measure to each set of parameters of the plurality of parameters; and
render a second image subsequent to subtracting the first noise measure from each set of parameters of the plurality of parameters.

6. The processing system of claim 1, wherein, to generate the first set of losses, the one or more processors are configured to execute the processor-executable instructions and cause the processing system to compare the first set of rendered images to one or more ground truth images.

7. The processing system of claim 6, wherein the one or more ground truth images were captured using one or more imaging devices.

8. The processing system of claim 1, wherein, to update the plurality of parameters based on the first set of losses, the one or more processors are configured to execute the processor-executable instructions and cause the processing system to:
compute a set of gradients based on the first set of losses; and
update the plurality of parameters based on the set of gradients using gradient descent.

9. The processing system of claim 8, wherein the one or more processors are configured to execute the processor-executable instructions and cause the processing system to compute the set of gradients according to
$$g = \vert v \vert * sign ( \frac{{l}_{+} - {l}_{-}}{v} ) ,$$
wherein:
g is the set of gradients,
v is the first noise measure, and
l₊ and l₋ are first and second losses, respectively, of the first set of losses.

10. The processing system of claim 1, wherein the one or more processors are configured to execute the processor-executable instructions and cause the processing system to refine the plurality of Gaussian kernels, wherein, to refine the plurality of Gaussian kernels, the one or more processors are configured to execute the processor-executable instructions and cause the processing system to:
generate a respective error value for each respective Gaussian kernel of the plurality of Gaussian kernels; and
for each respective Gaussian kernel having a respective error value that satisfies one or more criteria, either:
split the respective Gaussian kernel to form two new Gaussian kernels, or
clone the respective Gaussian kernel to form the two new Gaussian kernels.

11. The processing system of claim 10, wherein, to generate the respective error value for each respective Gaussian kernel, the one or more processors are configured to execute the processor-executable instructions and cause the processing system to:
generate a respective pixel error measure for each respective pixel of a set of pixels of at least a first rendered image of the first set of rendered images based on comparing the first rendered image to a ground truth image;
determine a respective blending ratio for each respective pixel of the set of pixels based on a respective subset of the plurality of Gaussian kernels that are depicted by the respective pixel; and
generate the respective error value for each respective Gaussian kernel based on the pixel error measures and the blending ratios.

12. The processing system of claim 10, wherein, to generate the respective error value for each respective Gaussian kernel, the one or more processors are configured to execute the processor-executable instructions and cause the processing system to, for each respective Gaussian kernel of the plurality of Gaussian kernels:
determine a respective first position of the respective Gaussian kernel during a prior iteration of updating the plurality of parameters;
determine a respective second position of the respective Gaussian kernel during a current iteration of updating the plurality of parameters; and
generate the respective error value based on a difference between the respective first and second positions.

13. The processing system of claim 1, wherein the processing system corresponds to at least one of (i) an edge device or (ii) user equipment (UE).

14. A processor-implemented method for view synthesis, comprising:
accessing a plurality of Gaussian kernels parameterized by a plurality of parameters, wherein the plurality of parameters comprises, for each respective Gaussian kernel of the plurality of Gaussian kernels, a respective set of parameters for a set of attributes;
determining a first set of norm values for the set of attributes based on the set of parameters;
generating a first noise measure based at least in part on the first set of norm values;
generating a first set of rendered images based on the plurality of Gaussian kernels and the first noise measure;
generating a first set of losses based at least in part on the first set of rendered images;
updating the plurality of parameters based on the first set of losses; and
generating an output rendered image based on the updated plurality of parameters for the plurality of Gaussian kernels.

15. The processor-implemented method of claim 14, wherein determining the first set of norm values is performed in response to determining that a current iteration of updating the plurality of parameters corresponds to a norm update iteration, the processor-implemented method further comprising, in response to determining that a subsequent iteration of updating the plurality of parameters does not correspond to a norm update iteration, using the first set of norm values during the subsequent iteration.

16. The processor-implemented method of claim 14, wherein generating the first set of rendered images comprises:
rendering a first image subsequent to adding the first noise measure to each set of parameters of the plurality of parameters; and
rendering a second image subsequent to subtracting the first noise measure from each set of parameters of the plurality of parameters.

17. The processor-implemented method of claim 14, further comprising refining the plurality of Gaussian kernels, comprising:
generating a respective error value for each respective Gaussian kernel of the plurality of Gaussian kernels; and
for each respective Gaussian kernel having a respective error value that satisfies one or more criteria, either:
splitting the respective Gaussian kernel to form two new Gaussian kernels, or
cloning the respective Gaussian kernel to form the two new Gaussian kernels.

18. The processor-implemented method of claim 17, wherein, generating the respective error value for each respective Gaussian kernel comprises:
generating a respective pixel error measure for each respective pixel of a set of pixels of at least a first rendered image of the first set of rendered images based on comparing the first rendered image to a ground truth image;
determining a respective blending ratio for each respective pixel of the set of pixels based on a respective subset of the plurality of Gaussian kernels that are depicted by the respective pixel; and
generating the respective error value for each respective Gaussian kernel based on the pixel error measures and the blending ratios.

19. The processor-implemented method of claim 17, wherein generating the respective error value for each respective Gaussian kernel comprises, for each respective Gaussian kernel of the plurality of Gaussian kernels:
determining a respective first position of the respective Gaussian kernel during a prior iteration of updating the plurality of parameters;
determining a respective second position of the respective Gaussian kernel during a current iteration of updating the plurality of parameters; and
generating the respective error value based on a difference between the respective first and second positions.

20. A processing system, comprising:
means for accessing a plurality of Gaussian kernels parameterized by a plurality of parameters, wherein the plurality of parameters comprises, for each respective Gaussian kernel of the plurality of Gaussian kernels, a respective set of parameters for a set of attributes;
means for determining a set of norm values for the set of attributes based on the set of parameters;
means for generating a noise measure based at least in part on the set of norm values;
means for generating a set of rendered images based on the plurality of Gaussian kernels and the noise measure;
means for generating a set of losses based at least in part on the set of rendered images;
means for updating the plurality of parameters based on the set of losses; and
means for generating an output rendered image based on the updated plurality of parameters for the plurality of Gaussian kernels.
